(19) United States
(12) Patent Application Publication
(10) Pub. No.: US 2012/0029758 A1
(43) Pub. Date: Feb. 2, 2012

(54) TELEMATICS UNIT AND METHOD AND SYSTEM FOR INITIATING VEHICLE CONTROL USING TELEMATICS UNIT INFORMATION

(75) Inventors: DAVID T. PROEFKE, Madison Heights, MI (US); WILLIAM A. BIONDO, Beverly Hills, MI (US); KEVIN R. KRAUSE, Plymouth, MI (US)

(73) Assignees: GENERAL MOTORS LLC, DETROIT, MI (US); GM GLOBAL TECHNOLOGY OPERATIONS, INC., DETROIT, MI (US)

(21) Appl. No.: 12/844,874

(22) Filed: Jul. 28, 2010

(51) Int. Cl. G06F 7/00

(52) U.S. Cl. 701/29; 701/1

(57) ABSTRACT

A method and system are provided for initiating control of a vehicle. A telematics unit includes a connector and a relay unit. The connector is configured to be coupled to a vehicle component. The relay unit is coupled to the connector, and is configured to provide information pertaining to the connector's coupling to the vehicle component. The immobilizer unit is configured to be coupled to the telematics unit, and includes a receiver and a processor. The receiver is configured to receive the information. The processor is coupled to the receiver, and is configured to initiate a measure of control of the vehicle if the information indicates that the telematics unit has been tampered with.

### TECHNICAL FIELD

The technical field generally relates to vehicles, and, more particularly, to telematics units and methods and systems for initiating vehicle control using telematics unit information.

### BACKGROUND

Many vehicles in the marketplace are equipped with telematics units. Certain telematics units are designed, constructed, and programmed to enable a user of the vehicle (hereinafter “user”) to interact with a communication network. The communication network includes a remotely located call center (hereinafter “call center”) staffed with live advisors (hereinafter “advisors”) who are trained to provide assistance to the user. Through the communication network, a user may utilize a wide variety of telematics services that are designed to facilitate and/or enhance the user's driving and/or vehicle ownership experience. Such services may include, but are not limited to, navigation assistance, vehicle monitoring, and telecommunication services. These telematics services may be provided by a manufacturer of the vehicle, by a manufacturer of the telematics units, or by some other telematics service provider.

Telematics units may also be used to initiate the taking of control over one or more aspects of vehicle operation. For example, after a vehicle has been stolen, a telematics unit of the vehicle may be utilized to determine the location of the vehicle, reduce the velocity of the vehicle, block the ignition of the vehicle, and/or otherwise immobilize the vehicle. However, it may be difficult to initiate such vehicle control in certain situations, for example in which the telematics unit has been tampered with.

Given the important nature of the role played by the immobilization system of the vehicle in providing mobility, it is desirable to minimize the components and circuits which have the potential to inhibit the normal operation which could result in the vehicle being immobilized for an authorized operator.

Accordingly, it is desirable to provide an improved method for initiating control over a vehicle using information from a telematics unit of the vehicle, for example in which the vehicle has been stolen and/or the telematics unit has been tampered with. It is further desirable to provide an improved system for initiating control over a vehicle using information from a telematics unit of the vehicle, for example in which the vehicle has been stolen and/or the telematics unit has been tampered with. It is further desirable to provide an improved telematics unit that provides information used for initiating control over a vehicle, for example in which the vehicle has been stolen and/or the telematics unit has been tampered with, which does not depend on highly complicated processes or components. Furthermore, other desirable features and characteristics of the present invention will become apparent from the subsequent detailed description and the appended claims, taken in conjunction with the accompanying drawings and the foregoing technical field and background.

### SUMMARY

In accordance with one example, a method for initiating control of a vehicle having a telematics unit is provided. The method comprises the steps of obtaining information from the telematics unit, and initiating a measure of control of the vehicle if the information indicates that the telematics unit has been tampered with.

In accordance with another example, a system for initiating control of a vehicle having a telematics unit is provided. The system comprises a receiver and a processor. The receiver is configured to receive information from the telematics unit. The processor is configured to initiate a measure of control of the vehicle if the information indicates that the telematics unit has been tampered with.

In accordance with a further example, a system for a vehicle is provided. The system comprises a telematics unit and an immobilizer unit. The telematics unit comprises a connector and a relay unit. The connector is configured to be coupled to a vehicle component. The relay unit is coupled to the connector, and is configured to provide information pertaining to the connector's coupling to the vehicle component. The immobilizer unit is configured to be coupled to the telematics unit, and comprises a receiver and a processor. The receiver is configured to receive the information. The processor is coupled to the receiver, and is configured to initiate a measure of control of the vehicle if the information indicates that the telematics unit has been tampered with.

### BRIEF DESCRIPTION OF THE DRAWINGS

Certain examples of the present disclosure will hereinafter be described in conjunction with the following drawing figures, wherein like numerals denote like elements, and wherein:

FIG. 1 is an exemplary schematic illustration of a non-limiting example of a communication system, including a telematics unit and an immobilizer unit that initiates control over the vehicle when the telematics unit is tampered with;

FIG. 2 is an exemplary functional block diagram of an immobilization system for initiating control over a vehicle, and that includes the telematics unit and the immobilizer unit of FIG. 1; and

FIG. 3 is a flowchart of an exemplary process for initiating control over a vehicle using information provided by a telematics unit, and that can be implemented using the communications system, the telematics unit, and the immobilizer unit of FIG. 1 and the immobilization system of FIG. 2.

### DETAILED DESCRIPTION

The following detailed description is merely exemplary in nature, and is not intended to limit the disclosure or the application and uses thereof. Furthermore, there is no intention to be bound by any expressed or implied theory presented in the preceding technical field, background, or the following detailed description.

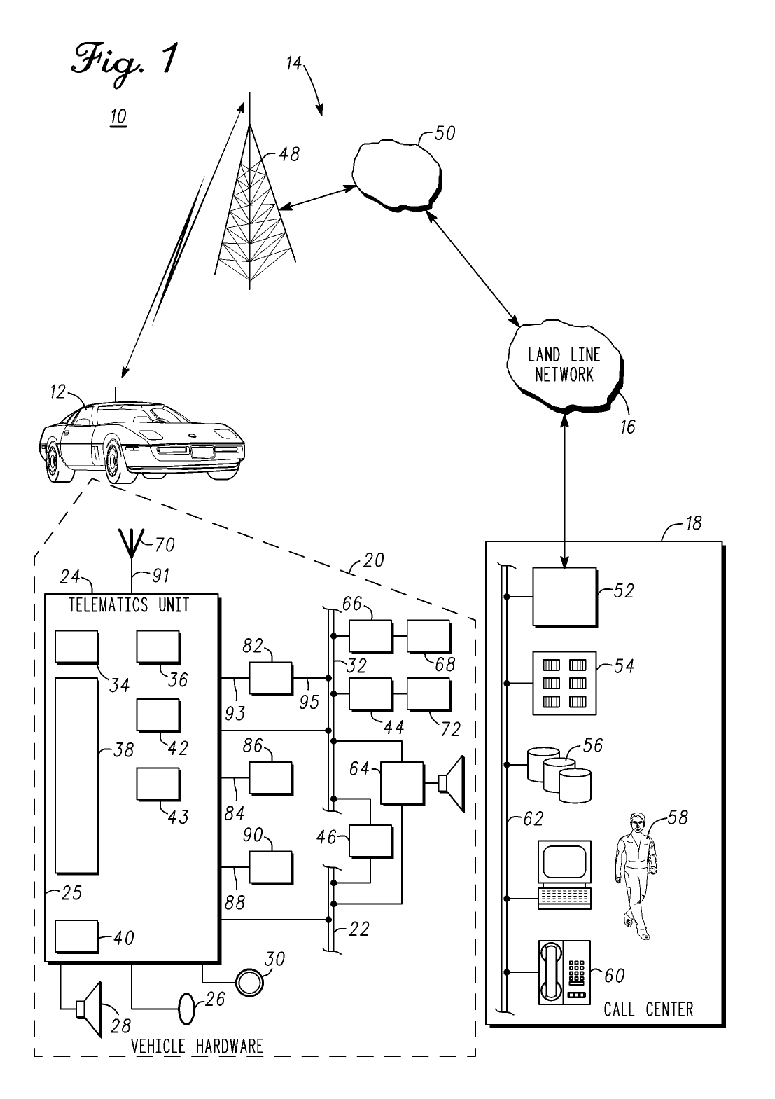

With reference to FIG. 1, there is shown a non-limiting example of a communication system 10 that may be used together with examples of the apparatus disclosed herein and to implement examples of the methods disclosed herein. The communication system generally includes a vehicle 12, a wireless carrier system 14, a land network 16, and a call center 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, and the like, and is equipped with suitable hardware and software that enables it to communicate over communication system 10. Some of the vehicle hardware 20 is shown generally in FIG. 1, including a telematics unit 24 and an immobilizer unit 82, as well as a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides information or other functions. In the depicted example, the telematics unit 24 is an onboard device that provides a variety of services through its communication with the call center 18. In certain other examples, the telematics unit 24 may comprise a stand-alone navigation device and/or another type of telematics unit that may not require the call center and/or certain other features of the communications system 10.

In the depicted example, the telematics unit 24 generally includes a housing 25, an electronic processing device 38, one or more types of electronic memory 40, a cellular chipset/component 34, a wireless modem 36, a dual mode antenna 70, a navigation unit containing a GPS chipset/component 42, and a relay unit 43. The electronic processing device 38, the one or more types of electronic memory 40, the cellular chipset/component 34, the wireless modem 36, the navigation unit containing the GPS chipset/component 42, and the relay unit 43 are preferably disposed within the housing 25. In one example, the wireless modem 36 includes a computer program and/or set of software routines adapted to be executed within the electronic processing device 38.

The telematics unit 24 may provide various services including: turn-by-turn directions and other navigation-related services provided in conjunction with the GPS chipset/component 42; airbag deployment notification and other emergency or roadside assistance-related services provided in connection with various crash and/or collision sensor interface modules 66 and collision sensors 68 located throughout the vehicle; and/or infotainment-related services where music, Internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. In order to enable successful data transmission over the voice channel, wireless modem 36 applies some type of encoding or modulation to convert the digital data so that it can be communicated through a vocoder or speech codec incorporated in the cellular chipset/component 34. Any suitable encoding or modulation technique that provides an acceptable data rate and bit error can be used with the present examples. Dual mode antenna 70 services the GPS chipset/component 42 and the cellular chipset/component 34.

Microphone 26 provides the user or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with call center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44, are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48, base stations and/or mobile switching centers (MSCs) 50, as well as any other networking components required to connect the wireless carrier system 14 with land network 16. As appreciated by those skilled in the art, various cell tower/base station/MSC arrangements are possible and could be used with wireless carrier system 14. For example, a base station and a cell tower could be co-located at the same site or they could be remotely located, and a single base station could be coupled to various cell towers or various base stations could be coupled with a single MSC, to list but a few of the possible arrangements. A speech codec or vocoder may be incorporated in one or more of the base stations, but depending on the particular architecture of the wireless network, it could be incorporated within a Mobile Switching Center or some other network components as well.

Land network 16 can be a conventional land-based telecommunication network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either the live advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a manned call center 18, it will be appreciated that the call center 18 can be any central or remote facility, manned or unmanned, mobile or fixed, to or from which it is desirable to exchange voice and data. In addition, in certain examples, the telematics unit 24 may not use or require a call center and/or various other features set forth in FIG. 1 or described above.

The telematics unit 24 also operates along with the immobilizer unit 82 in initiating control over the vehicle when the vehicle is stolen or is otherwise operated by an unauthorized user who has tampered with the telematics unit 24. As used throughout this application, a telematics unit is deemed to be tampered with if any vehicle components are disconnected from the telematics unit, any connections between the telematics unit and any vehicle components are otherwise impaired, any components of the telematics unit are destroyed, impaired, or removed, or the telematics unit is otherwise interfered with or tampered with.

In the depicted example, the telematics unit 24 includes a first connector 84, a second connector 88, a third connector 91, and a fourth connector 93, in addition to the above-mentioned relay unit 43. The first connector 84 comprises a connector (for example, a cable or wire) configured to be electrically connected to a vehicle voltage source 86 and receives voltage therefrom. In one example, the vehicle voltage source 86 comprises a vehicle battery, such as a twelve volt vehicle battery. The second connector 88 comprises a connector (for example, a cable or wire) configured to be electrically connected to a vehicle ground unit 90. The third connector 91 comprises a connector (for example, a cable or wire) configured to be coupled to the antenna 70. The fourth connector 93 comprises a connector (for example, a cable, a wire, or a wireless connection) configured to be coupled to the immobilizer unit 82.

The relay unit 43 relays information or signals from the first second, and third connectors 84, 88, 91, to the immobilizer unit 82 along the fourth connector 93 for processing by the immobilizer unit 82. Specifically, the relay unit 43 relays voltage information regarding the voltage received from the voltage source 86 by the telematics unit 24 (including information as to whether the connection between the voltage source 86 and the telematics unit 24 has been disconnected or as to whether the telematics unit 24 has otherwise been tampered with), ground information regarding the connection between the vehicle ground unit 90 and the telematics unit 24 (including information as to whether the connection between the vehicle ground unit 90 and the telematics unit 24 has been disconnected or as to whether the telematics unit has otherwise been tampered with), and antenna information regarding the connection between the antenna 70 and the telematics unit 24 (including information as to whether the connection between the antenna 70 and the telematics unit 24 has been disconnected or as to whether the telematics unit has otherwise been tampered with), all to the immobilizer unit 82 for processing. The relay unit 43 may also provide encoded messages to the immobilizer unit 82 via the fourth connector 93 for verification by the immobilizer unit 82. In one example, the relay unit relies solely on the presence of voltage to provide electromagnetic closure of proximal switch contacts for the purpose of sending a “go/no go” signal to the immobilizer unit. In a second example, the relay unit 43 includes various sensors and/or switches for providing the voltage information, ground information, antenna information, and encoded message information. For the purposes of providing encoded messages to the immobilizer unit 82 without relying on the proper operation of the telematics processor unit 38, cellular chipset 34, or wireless modem 36, the relay unit 43 may contain memory storage, shift registers, or additional modulation chips or components to communicate the contents of the memory storage unit to the immobilizer unit.

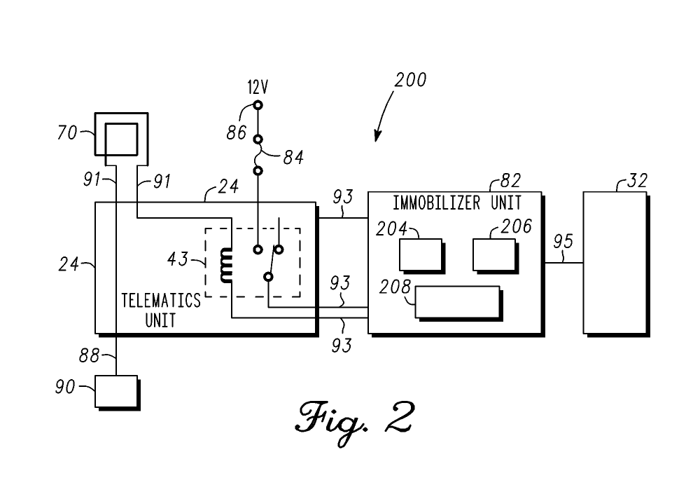

With reference to FIG. 2, a functional block diagram of an immobilization system 200 is provided for initiating control over the vehicle when a telematics unit for the vehicle has been tampered with. As depicted in FIG. 2, the immobilization system 200 includes the telematics unit 24 of FIG. 1 (including the relay unit 43 and the first second, third, and fourth connectors 84, 88, 91, and 93 thereof) and the immobilizer unit 82 of FIG. 1. The immobilizer unit 82 is preferably disposed outside the housing 25 of the telematics unit 24 of FIG. 1.

As depicted in FIG. 2, the immobilizer unit 82 includes a processor 204, a memory 206, and a receiver/transceiver 208. In certain examples, the receiver/transceiver 208 comprises one or more transceivers. In certain other examples, the receiver/transceiver 208 comprises one or more separate receivers and transmitters. Also as depicted in FIG. 2, the immobilizer unit 82 is coupled between the telematics unit 24 and the vehicle bus 32, for authorization of vehicle operation, for example to an engine control module coupled to the vehicle bus 32. Specifically, the receiver/transceiver 208 is preferably coupled to the telematics unit 24 via one or more fourth connectors 93 (such as those referenced above), and is further coupled to the vehicle bus 32 via one or more fifth connectors 95. Similar to the fourth connectors 93 described above, the fifth connectors 95 may also include one or more wireless and/or wired connections.

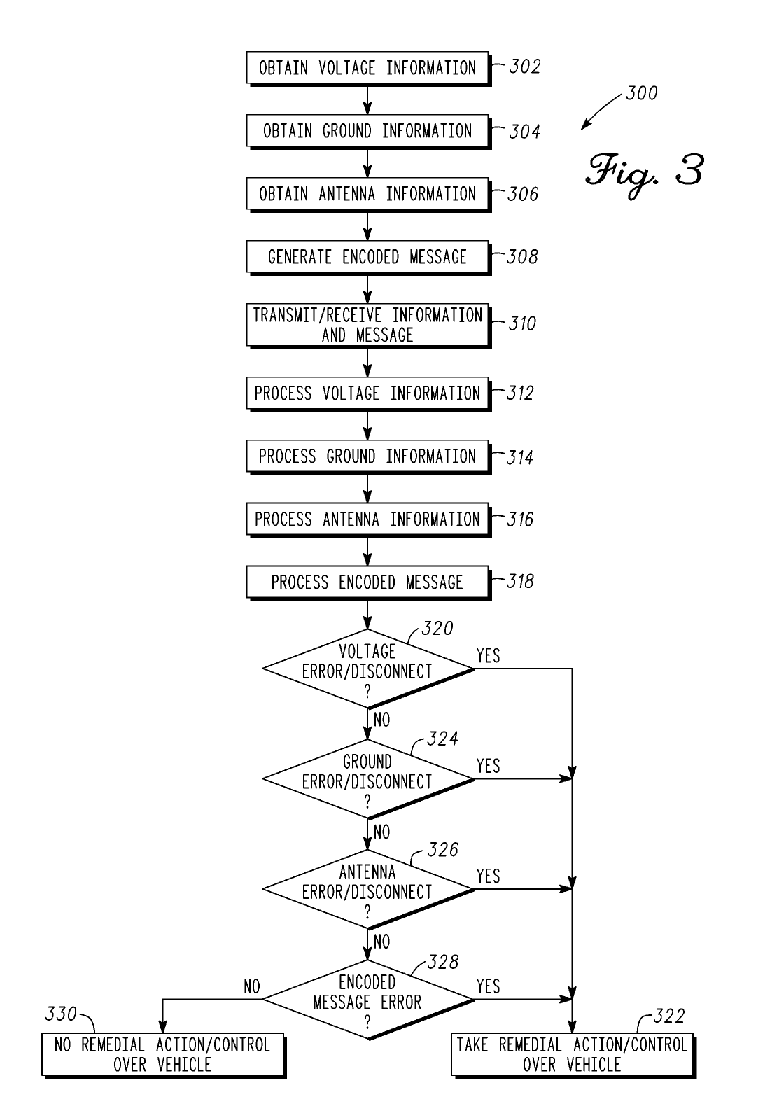

The receiver/transceiver 208 receives the voltage information, the ground information, the antenna information, and the encoded messages (if any) from the telematics unit 24 via the fourth connectors 93, and provides this information to the processor 204. The processor 204 processes the voltage information, the ground information, the antenna information, and the encoded messages (if any) and compares them with respective known or expected values of the voltage information, the ground information, the antenna information, and the encoded messages (if any) stored in the memory 206, and determines whether there are any errors based on these comparisons. Preferably, if any of the voltage information, the ground information, the antenna information, and the encoded messages (if any) differ from their respective values to at least a predetermined extent such that the telematics unit 24 and/or one or more connections thereto appear to have been tampered with, then the processor 204 initiates control over the vehicle via instructions provided to one or more other vehicle components (for example, an engine control module, by way of example only) via the vehicle bus 32. The immobilizer unit 82 and the immobilization system 200 preferably perform these functions in accordance with steps of the process 300 set forth in FIG. 3 and described directly below in connection therewith.

FIG. 3 is a flowchart of an exemplary process 300 for initiating control over a vehicle using information provided by a telematics unit. The process 300 can be implemented using the communications system 10, the telematics unit 24, and the immobilizer unit 82 of FIG. 1 as well as the immobilization system 200 of FIG. 2.

As depicted in FIG. 3, the process 300 includes the step of obtaining voltage information (step 302). In one example, during step 302, the voltage information relates to an amount of voltage received by the telematics unit 24 of FIGS. 1 and 2 from the vehicle voltage source 86 of FIGS. 1 and 2 via the first connector 84 of FIGS. 1 and 2. The voltage information is preferably provided to the processor 204 of FIG. 2 of the immobilizer unit 82 of FIGS. 1 and 2 via the relay unit 43 of FIGS. 1 and 2, one or more fourth connectors 82 of FIGS. 1 and 2, and the receiver/transceiver 208 of FIG. 2.

In addition, ground information is obtained (step 304). In one example, during step 304, the ground information relates to a connection between (for example, a flow of power or energy between) the ground unit 90 of FIGS. 1 and 2 and the telematics unit 24 of FIGS. 1 and 2 via the second connector 88 of FIGS. 1 and 2. The ground information is preferably provided to the processor 204 of FIG. 2 of the immobilizer unit 82 of FIGS. 1 and 2 via the relay unit 43 of FIGS. 1 and 2, one or more fourth connectors 82 of FIGS. 1 and 2, and the receiver/transceiver 208 of FIG. 2.

Antenna information is also obtained (step 306). In one example, during step 306, the antenna information relates to a connection between (for example, an exchange of signals or other communications between) the antenna 70 of FIGS. 1 and 2 and the telematics unit 24 of FIGS. 1 and 2 via the third connector 91 of FIGS. 1 and 2. The antenna information is preferably provided to the processor 204 of FIG. 2 of the immobilizer unit 82 of FIGS. 1 and 2 via the relay unit 43 of FIGS. 1 and 2, one or more fourth connectors 82 of FIGS. 1 and 2, and the receiver/transceiver 208 of FIG. 2.

In certain examples, an encoded message is generated (step 308). The encoded message is preferably generated by components within the relay device 43, and preferably includes an indication of whether the telematics unit 24 of FIGS. 1 and 2 has been tampered with. In one example, the encoded message may include a first value when the telematics unit 24 has not been tampered with, and a second value when the telematics unit 24 has been tampered with. In certain examples, the encoded message may be sent instead of one or more of the voltage information, the ground information, and/or the antenna information. In certain other examples, the encoded message may be sent in addition to one or more of the voltage information, the ground information, and/or the antenna information. In other examples, the encoded message may also be generated by the electronic processing device 38. The encoded message is preferably provided to the processor 204 of FIG. 2 of the immobilizer unit 82 of FIGS. 1 and 2 via the relay unit 43 of FIGS. 1 and 2, one or more fourth connectors 82 of FIGS. 1 and 2, and the receiver/transceiver 208 of FIG. 2.

The voltage information, the ground information, the antenna information, and the encoded messages (if any) are transmitted and received (step 310). Specifically, the voltage information, the ground information, the antenna information, and the encoded messages (if any) are preferably transmitted by the relay unit 43 of FIGS. 1 and 2 to the receiver/transceiver 208 along one or more third connectors 82 of FIGS. 1 and 2, and are then preferably supplied to the processor 204 of FIG. 2.

The voltage information, the ground information, the antenna information, and the encoded messages (if any) are each then processed (steps 312-318). Preferably, the processor 204 of FIG. 2 compares (i) the voltage information from step 302 to known voltage information values stored in the memory 206 of FIG. 2 (step 312); (ii) the ground information from step 304 to known ground information values stored in the memory 206 (step 314); (iii) the antenna information from step 306 to known antenna information values stored in the memory 206 (step 316); and (iv) the encoded message (if any) of step 308 to known encoded messages stored in the memory 206 (step 318).

A determination is then made as to whether a voltage error is detected (step 320). A voltage error is determined to be detected if the voltage information from step 302 is different to at least a predetermined extent from known values of voltage information in which the telematics unit 24 of FIGS. 1 and 2 has not been tampered with, for example the voltage information indicates that the telematics unit is experiencing less than nine Volts of voltage through connector 84. Thus, a voltage error is deemed to represent that the telematics unit 24 has been tampered with in some manner. Preferably the determination of step 320 is made by the processor 204 of FIG. 2.

If it is determined that a voltage error is detected, then remedial action is taken with an initiation of control over one or more aspects of operation of the vehicle (step 322). In one example, the vehicle control comprises a reduction in velocity of the vehicle. In another example, the vehicle control comprises a locking of an ignition of the vehicle. In still another example, the vehicle control comprises a reduction in velocity and a locking of an ignition of the vehicle. In various other examples, one or more other different types of vehicle control may also be initiated, either instead of or in addition to those noted above. The vehicle control is preferably initiated by the processor 204 of FIG. 2 via commands sent to one or more other vehicle units (for example, a steering column, an engine control module, and/or a braking unit, by way of example only) via the vehicle bus 32 of FIGS. 1 and 2. In one example, the instructions are provided to the vehicle bus 32 via the transceiver 208 of FIG. 2 along the fifth connector 95 of FIGS. 1 and 2.

Conversely, if it is determined that a voltage error is not detected, then a determination is made as to whether a ground error is detected (step 324). A ground error is determined to be detected if the ground information from step 304 is different to at least a predetermined extent from known values of ground information in which the telematics unit 24 of FIGS. 1 and 2 has not been tampered with. Thus, a ground error is deemed to represent that the telematics unit 24 has been tampered with in some manner. Preferably the determination of step 324 is made by the processor 204 of FIG. 2.

If it is determined that a ground error is detected, then the process proceeds to the above-mentioned step 322, in which remedial action is taken with an initiation of control over one or more aspects of operation of the vehicle. Conversely, if it is determined that a ground error is not detected, then a determination is made as to whether an antenna error is detected (step 326). An antenna error is determined to be detected if the antenna information from step 306 is different to at least a predetermined extent from known values of antenna information in which the telematics unit 24 of FIGS. 1 and 2 has not been tampered with. Thus, an antenna error is deemed to represent that the telematics unit 24 has been tampered with in some manner. Preferably the determination of step 326 is made by the processor 204 of FIG. 2.

If it is determined that an antenna error is detected, then the process proceeds to the above-mentioned step 322, in which remedial action is taken with an initiation of control over one or more aspects of operation of the vehicle. Conversely, if it is determined that an antenna error is not detected, then a determination is made as to whether an encoded message error is detected (step 328). An encoded message error is determined to be detected if the encoded message information from step 308 is different to at least a predetermined extent from known values of encoded message information in which the telematics unit 24 of FIGS. 1 and 2 has not been tampered with. Thus, an encoded message error is deemed to represent that the telematics unit 24 has been tampered with in some manner. Preferably the determination of step 328 is made by the processor 204 of FIG. 2.

If it is determined that an encoded message error is detected, then the process proceeds to the above-mentioned step 322, in which remedial action is taken with an initiation of control over one or more aspects of operation of the vehicle. Conversely, if it is determined that an encoded message error is not detected, then no remedial action is taken, and no control over the vehicle is initiated (step 330).

Thus, if any of the voltage information, ground information, antenna information, or encoded message information indicates that the telematics unit has been tampered with, then control over the vehicle (for example, vehicle slowing and/or ignition blocking) is initiated. In certain circumstances, such vehicle control may be initiated automatically by the immobilizer unit. In certain other circumstances, such vehicle control is initiated only after additional instructions are provided, for example from a call center or from law enforcement authorities. If none of the voltage information, ground information, antenna information, or encoded message information indicates that the telematics unit has been tampered with, then control over the vehicle is not initiated. In certain examples, obtaining, generating, and/or processing of one or more of the voltage information, the ground information, the antenna information, and/or the encoded message information may not be needed, and/or may be conducted in a different order than described above and/or in connection with the flowchart of FIG. 3, among other possible variations to the process 300.

Accordingly, methods and systems are disclosed for initiating control over a vehicle. The disclosed methods and systems allow for effective initiation of control over a vehicle (such as a slowing of the vehicle and/or a blocking of an ignition of the vehicle, by way of example only) when the telematics unit of the vehicle has been tampered with. The disclosed methods and systems can be implemented in connection with various different types of telematics units and vehicles.

It will be appreciated that the disclosed systems and processes may differ from those depicted in the figures and/or described above. For example, the communications system 10, the telematics unit 24, the immobilizer unit 82, and/or various parts and/or components thereof may differ from those of FIG. 1 and/or described above. Similarly, the immobilization system 200 and/or various parts and/or components thereof may differ from those of FIG. 2 and/or described above. Likewise, certain steps of the process 300 may be unnecessary and/or may vary from those depicted in FIG. 3 and/or described above. It will similarly be appreciated that various steps of the process 300 may occur simultaneously or in an order that is otherwise different from that depicted in FIG. 3 and/or described above. It will similarly be appreciated that, while the disclosed methods and systems are described above as being used in connection with automobiles such as sedans, trucks, vans, and sports utility vehicles, the disclosed methods and systems may also be used in connection with any number of different types of vehicles, and in connection with any number of different systems thereof and environments pertaining thereto.

While at least one example has been presented in the foregoing detailed description, it should be appreciated that a vast number of variations exist. It should also be appreciated that the detailed description represents only examples, and is not intended to limit the scope, applicability, or configuration of the invention in any way. Rather, the foregoing detailed description will provide those skilled in the art with a convenient road map for implementing the examples. It should be understood that various changes can be made in the function and arrangement of elements without departing from the scope of the invention as set forth in the appended claims and the legal equivalents thereof.

What is claimed is:

1. A method for initiating control of a vehicle having a telematics unit, the method comprising the steps of:
obtaining information from the telematics unit; and
initiating a measure of control of the vehicle if the information indicates that the telematics unit has been tampered with.

2. The method of claim 1, wherein:
the step of obtaining the information comprises the step of obtaining voltage information pertaining to a voltage provided to the telematics unit from a voltage source of the vehicle; and
the step of initiating the measure of control comprises the step of initiating the measure of control if the voltage information is different from an expected voltage value.

3. The method of claim 1, wherein:
the step of obtaining the information comprises the step of obtaining ground information pertaining to a connection between the telematics unit and a ground unit of the vehicle; and
the step of initiating the measure of control comprises the step of initiating the measure of control if the ground information indicates that the telematics unit has been tampered with.

4. The method of claim 1, wherein:
the step of obtaining the information comprises the step of obtaining antenna information pertaining to a connection between the telematics unit and an antenna; and
the step of initiating the measure of control comprises the step of initiating the measure of control if the antenna information indicates that the telematics unit has been tampered with.

5. The method of claim 1, wherein:
the step of obtaining the information comprises the step of obtaining an encoded message from the telematics unit; and
the step of initiating the measure of control comprises the step of initiating the measure of control if the encoded message is different from an expected encoded message value.

6. The method of claim 1, wherein the step of initiating the measure of control comprises the step of:
reducing a velocity of the vehicle if the information indicates that the telematics unit has been tampered with.

7. The method of claim 1, wherein the step of initiating the measure of control comprises the step of:
blocking an ignition of the vehicle if the information indicates that the telematics unit has been tampered with.

8. A system for initiating control of a vehicle having a telematics unit, the system comprising:
a receiver configured to receive information from the telematics unit; and
a processor configured to initiate a measure of control of the vehicle if the information indicates that the telematics unit has been tampered with.

9. The system of claim 8, wherein:
the receiver is configured to receive voltage information pertaining to a voltage provided to the telematics unit from a voltage source of the vehicle; and
the processor is configured to initiate the measure of control if the voltage information is different from an expected voltage value.

10. The system of claim 8, wherein:
the receiver is configured to receive ground information pertaining to a connection between the telematics unit and a ground unit of the vehicle; and
the processor is configured to initiate the measure of control if the ground information indicates that the telematics unit has been tampered with.

11. The system of claim 8, wherein:
the receiver is configured to receive antenna information pertaining to a connection between the telematics unit and an antenna; and
the processor is configured to initiate the measure of control if the antenna information indicates that the telematics unit has been tampered with.

12. The system of claim 8, wherein:
the receiver is configured to receive an encoded message from the telematics unit; and
the processor is configured to initiate the measure of control if the encoded message is different from an expected encoded message value.

13. The system of claim 8, wherein the processor is configured to initiate a reduction of a velocity of the vehicle if the information indicates that the telematics unit has been tampered with.

14. The system of claim 8, wherein the processor is configured to initiate a blocking of an ignition of the vehicle if the information indicates that the telematics unit has been tampered with.

15. A system for a vehicle, the system comprising:
a telematics unit comprising:
a connector configured to be coupled to a vehicle component; and
a relay unit coupled to the connector and configured to provide information pertaining to the connector's coupling to the vehicle component; and
an immobilizer unit configured to be coupled to the telematics unit, the immobilizer unit comprising:
a receiver configured to receive the information; and
a processor coupled to the receiver, the processor configured to initiate a measure of control of the vehicle if the information indicates that the telematics unit has been tampered with.

16. The system of claim 15, wherein the vehicle component comprises a voltage source of the vehicle.

17. The system of claim 15, wherein the vehicle component comprises a ground unit of the vehicle.

18. The system of claim 15, wherein the vehicle component comprises an antenna of the vehicle.

19. The system of claim 15, wherein the processor is configured to initiate a reduction in velocity of the vehicle if the information indicates that the telematics unit has been tampered with.

20. The system of claim 15, wherein the processor is configured to initiate a blocking of an ignition of the vehicle if the information indicates that the telematics unit has been tampered with.
